(19) United States
(12) Patent Application Publication
(10) Pub. No.: US 2007/0011109 A1
(43) Pub. Date: Jan. 11, 2007

(54) Immortal information storage and access platform

(75) Inventors: Andrew D. Wilson, Seattle, WA (US); Eric J. Horvitz, Kirkland, WA (US); Dimitris Achlioptas, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/159,626

(22) Filed: Jun. 23, 2005

(51) Int. Cl. G06F 17/00

(52) U.S. Cl. 706/11

(57) ABSTRACT

Immortal information storage is leveraged to provide an interactive means to retrieve information associated with a physical artifact. The information persists for a substantial portion of the life of the artifact. This allows users to interact with an artifact that symbolically represents an entity, where the entity can be an organic and/or non-organic entity. A physical artifact that symbolically represents a person, animal, or a structure can be utilized. The storage system can contain easy to discover information about building a decoder or providing power and interpreting the information stored therein. A personalized interaction model can also be utilized to facilitate in providing an interactive model that responds to user queries in a fashion characteristic of the entity. Access to the immortalized information can be controlled by identity of entity seeking access, the amount of time that has passed, or events that have occurred. Power for facilitating retrieval of the information can be from thermal, induction, acoustical, and/or light-based sources. A separate User Interface (UI)/Reader can also be employed to inductively provide power to interact with the immortal information and to provide an interface for the user.

### BACKGROUND

The world continues to produce information at a staggering rate. Technological advances allow this rate to constantly increase year after year. Vast amounts of valuable knowledge are stored precariously on storage devices such as hard drives and other magnetic types of media. Unfortunately, a great deal of this information will be lost to future generations because of the limited longevity of the storage media and also the limited foresight of those who possess the information. Thus, typically, after several decades, the storage media will fail and/or the information possessor will forget the information or pass away. Either way, the lack of establishing some type of permanency of the information will result in the loss of a great deal of knowledge. Part of the reason for this occurring is that society has become more of a ‘throw-away’ society. Ironically, as society moves to a greater intellectual state and farther from a physical society, the loss of information will have a greater profound effect on society as a whole. This is due partly because the magnitude of technological advances has increased such that a small amount of information can yield substantial benefits. And, accordingly, it takes less effort to lose this information through carelessness or lack of forethought.

Another problem induced by the vast amount of information produced is the greater risk of losing information simply because it cannot be found. If a book is misplaced in a large library, there is only a slim chance that it will ever be found again. And, certainly, one who seeks the knowledge in the book will only know to look where it is supposed to be and not where it actually has been placed. This can also be likened to a popular World Wide Web page that contains vast amounts of information. If the maintainer of the information breaks the ties between the URL and the content, it can be lost forever. Users of the website will not know where to look for the information, resulting in the loss of the information to society as a whole even though it still exists somewhere, on some server, someplace.

As information increases, society utilizes high density technologies to store the information. Typically, this enables greater amounts of information to be stored in smaller spaces, drastically increasing the value per size of the storage media. In general, these types of technologies are more delicate and have a decreased life expectancy, exposing the information stored on these devices to a greater risk of loss. It is possible in the near future that a dime-sized storage device may house the entire knowledge of the human race. Imagine flipping such a coin and watching in horror as it rolls down into a storage drain, disappearing forever. That simply and that quickly, it is gone without a trace. Society as a whole needs to become more aware of these issues in order to preserve valuable assets that exist today on these fragile devices.

In ancient times, before the advent of written words and other primitive storage devices, knowledge was passed down from generation to generation by word of mouth. Elders of a community possessed the most knowledge and passed it down to the younger members of the community who in turn passed it down and so forth. In this manner, the knowledge of the community was maintained. However, if, for example, a tragic event such as a viral outbreak or a natural disaster struck and most of the community was lost, their knowledge would be lost with them as well. It is common for archeologists to uncover unknown civilizations for this very reason. Artifacts exist to prove that the civilization did indeed exist, but knowledge of who the people were and their history is lost forever.

It is normal for people as they grow older to reflect on their lives and realize how fragile their own experiences and knowledge truly are. Sometimes people have short life spans that do not enable them to pass information from one generation to another. Oftentimes, grandparents are the historians of the family and teach their grandchildren about their relatives. Thus, it is more likely that a first generation might not coexist at the same time as a third generation, causing the loss of this familial information. Parents who were close to their parents often feel that it is essential that their children learn and understand what their grandparents were like if they have passed before the children were born. Additionally, sometimes a person becomes an important part of society and their views and knowledge become essential to more than just their immediate family. In most societies, these important historical figures are studied in depth to “get to know them” and learn who they are. Writings, notes, books, and photographs and other information is utilized to convey the personalities of these individuals. However, sometimes these types of information are not in abundance and/or are not available at all, leaving historians to speculate or to rely on third party accounts as to why the individual did this, said this, or thought this. Without more, the debate on the veracity of the conjecture can last for an eternity.

Obviously, it is of great importance to be able to maintain knowledge, whether of personal family, societal figures, or even technological know-how. However, as evidenced by archeologists time and again, delicate storage devices such as paper either did not exist or did not survive over time. It is the relics or physical artifacts of the past that endure the test of time. Thus, the archeologists are left to decipher drawings on pots and shapes of carvings in stone to determine who these people were and how they lived in general, but never able to learn detailed knowledge about the individuals themselves. Imagine if the Great Pyramids could reveal not only secret tunnels and tombs, but could also pass knowledge of how and when it was built. Imagine still if the tombs could reveal information not only about the person entombed, but also information directly from the person—in a living retrospect of how they perceived themselves, revealing their true personalities. This would greatly increase society's present day knowledge of past cultures and individuals. In a few hundred years, our current society will be studied and learned as past societies are today. Imagine the great wealth of information that can be passed on to future generations if steps could be taken to preserve the information of today for tomorrow.

### SUMMARY

The following presents a simplified summary of the subject matter in order to provide a basic understanding of some aspects of the subject matter. This summary is not an extensive overview of the subject matter. It is not intended to identify key/critical elements of the subject matter or to delineate the scope of the subject matter. Its sole purpose is to present some concepts of the subject matter in a simplified form as a prelude to the more detailed description that is presented later.

The subject matter relates generally to information storage, and more particularly to systems and methods for storing and retrieving self-disclosing, persistent information associated with a physical artifact. Immortal information storage is leveraged to provide an interactive means to retrieve the information associated with the physical artifact. The information persists for a substantial portion of the life of the artifact. This allows users to interact with an artifact that symbolically represents an entity, where the entity can be an organic and/or non-organic entity such as, for example, a person or a structure and the like. One instance utilizes a tombstone, urn, and/or memorial as the physical artifact that symbolically represents the remains of a person and/or animal and the like. Another instance utilizes a building cornerstone as the physical artifact to symbolically represent a building and/or other structures and the like. These instances allow a user to interact with the immortalized information to learn about the entity represented by the artifact. In yet another instance, a personalized interaction model is utilized to facilitate in providing an interactive model that responds to user queries in a fashion characteristic of the entity.

Access to the immortalized information can be based upon biometrics and other control techniques. Power for facilitating retrieval of the information can be from thermal-based sources, magnetic induction-based sources, chemical sources, acoustical-based sources, and/or light energy-based sources and the like. One instance utilizes a separate User Interface (UI)/Reader to inductively provide power to interact with the immortal information and to provide an interface for the user. In still other instances, the UI/Reader can be upgraded to allow a series of capability layers that interact with the immortalized information, providing additional features such as interactive models, holographic imaging, video, audio and/or other forms of sensory information. These instances can provide invaluable information to future generations of users for the approximate life of the physical artifact, greatly increasing the historical knowledge of society as a whole.

To the accomplishment of the foregoing and related ends, certain illustrative aspects of the subject matter are described herein in connection with the following description and the annexed drawings. These aspects are indicative, however, of but a few of the various ways in which the principles of the subject matter may be employed and the subject matter is intended to include all such aspects and their equivalents. Other advantages and novel features of the subject matter may become apparent from the following detailed description of the subject matter when considered in conjunction with the drawings.

### BRIEF DESCRIPTION OF THE DRAWINGS

FIG. 1 is a block diagram of an immortal information system in accordance with an aspect of an embodiment.

FIG. 2 is another block diagram of an immortal information system in accordance with an aspect of an embodiment.

FIG. 3 is yet another block diagram of an immortal information system in accordance with an aspect of an embodiment.

FIG. 4 is a flow diagram of a method of facilitating immortal information storage and retrieval in accordance with an aspect of an embodiment.

FIG. 5 is a flow diagram of a method of interacting with personalized immortal information in accordance with an aspect of an embodiment.

FIG. 6 illustrates an example operating environment in which an embodiment can function.

FIG. 7 illustrates another example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that the subject matter may be practiced without these specific details. In other instances, well-known structures and devices are shown in block diagram form in order to facilitate describing the subject matter.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

Instances of the subject matter provide a self-disclosing device that utilizes a simplistic means to interact with persistent information for a substantial portion of the life of an associated physical artifact. Retrieval of the information is facilitated by power sources that can reside within and/or external to the physical artifact. Thus, techniques such as inductive, thermal, and/or light-energy based sources, can be utilized to facilitate interaction with the persistent or “immortal” information. This allows instances to utilize a power source from a separate User Interface (UI)/Reader to interact with the information without physically coupling to an embedded immortal information storage device. Instances can also utilize similar technologies as a communication means to interact with the information without physically coupling to an embedded immortal information storage device. This eliminates, for example, problems related to break downs at the connector level for power and/or communications—both by breaking physically and by changing interface standards. The interaction with the immortal information can be denoted as “immortal computing” due to its longevity. These instances of the subject matter eliminate the need for direct intervention to maintain information as is commonly done today. This ensures that the information will be prolonged in its desired state, typically as desired by an entity on which the information is based. The breadth of the information can be solely dependent upon the entity and also trusted to allow complete and ensured control over the immortal information.

The UI/Reader can also be utilized to enhance the immortal information retrieval process and also to facilitate in access control. Information retrieval can include visual experiences along with audio and even holographic imaging. A personalized interaction model can also be employed to provide an interactive experience where a user can submit queries that are then responded to in a manner that is consistent with the personality of the entity. By standardizing the interface for reading immortal information and the power interface, long-term retrieval capability can be assured to a high degree. In a typical instance, the immortal information is stored on devices with non-moving parts to ensure that the information will not be lost due to mechanical type failures. Communication with the immortal information through the UI/Reader can be accomplished utilizing inductive, chemical, thermal, and/or light-based communication means as well as traditional means.

Thus, the subject matter provides a means to create legacies, not only for organic entities, but inorganic entities as well. For example, a building structure that represents a unique feat of engineering can employ an instance of the subject matter in a cornerstone of the structure. For at least a substantial portion of the life of the cornerstone, users can interact with the cornerstone via a UI/Reader and obtain information about how the structure was built. This can resolve many archeological uncertainties for future generations and also add a human touch to the building by providing information on who built the structure as well. In another example, a statue and/or sculpture can incorporate an instance of the subject matter to allow users to interact with the object and learn details about the object and/or the creator of the object.

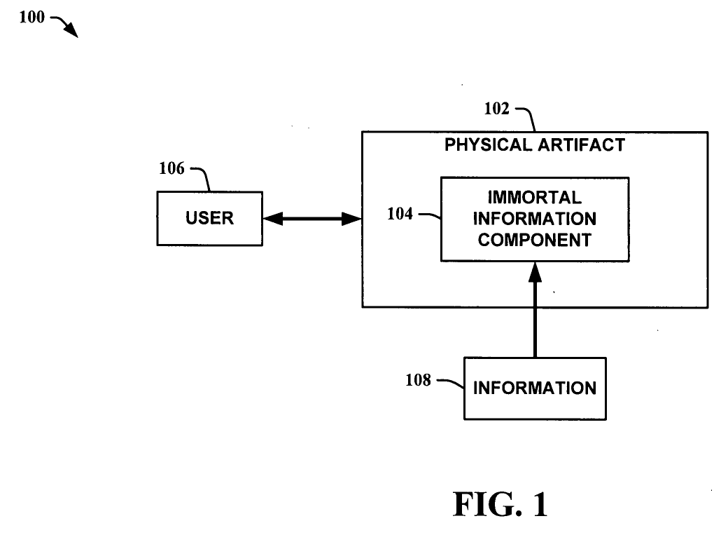

In FIG. 1, a block diagram of an immortal information system 100 in accordance with an aspect of an embodiment is shown. The immortal information system 100 is comprised of a physical artifact 102 and an immortal information component 104 that interacts with a user 106. The immortal information component 104 receives information 108 and persistently stores it 108. In order to ensure longevity of the stored information, storage technology that utilizes techniques that do not require moving parts are typically employed. This can include flash memory, etching of durable substances such as rocks and minerals, and/or imaging techniques that provide a durable image of the information and the like. For example, holographic images representing the information 108 can be laser etched into a diamond substrate and the like. Pitting techniques utilized in compact disc (CD) and/or digital video disc (DVD) technologies can be adjusted for utilization with more durable substrate material such as rock and the like.

In some instances, the physical artifact 102 and the stored information utilize substantially similar materials. This enables the information 108 to essentially last as long as the physical artifact 102 lasts. Storage of the information 108 is accomplished in such a manner that the information 108 is “self-disclosing” (i.e., does not require extensive interpretation to reveal itself). Thus, the information 108 can be obtained for long durations of time without requiring complex, non-durable extraction means that have limited life spans. This increases the amount of time that the user 106 can interact with the immortal information component 104. This allows, for example, future generations of a deceased person to interact with the immortal information and learn about their deceased ancestor. However, other instances utilize an “entity” that can be inorganic as well as organic. This allows immortal information to be provided for structures such as buildings, monuments, art work, and statues and the like as well. A user can approach and interact with a non-organic entity associated physical artifact and obtain information similarly to organic entity based examples described above.

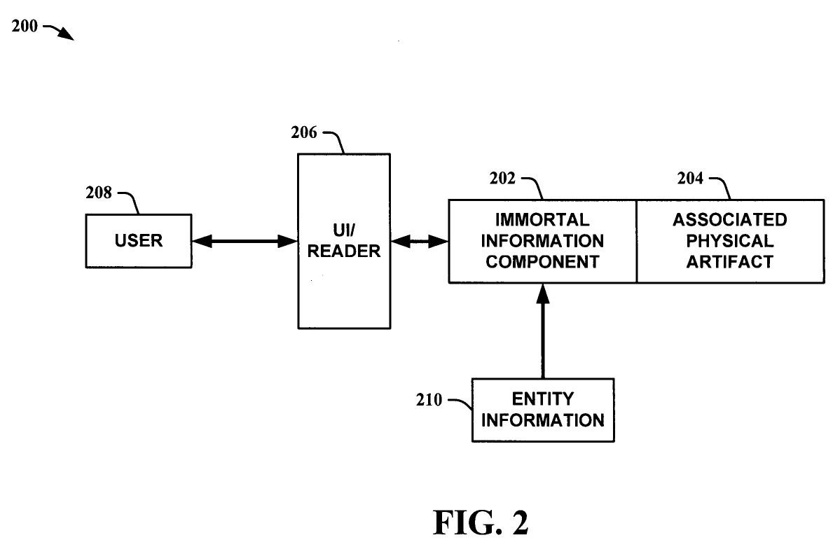

Referring to FIG. 2, another block diagram of an immortal information system 200 in accordance with an aspect of an embodiment is illustrated. The immortal information system 200 is comprised of an associated physical artifact 204, an immortal information component 202, and a User Interface (UI)/Reader 206. The UI/Reader 206 interfaces with a user 208. The immortal information component 202 receives entity information 210 and persistently stores it 210 in a self-disclosing manner. The immortal information component 202 can be embedded into the associated physical artifact 204, attached to the associated physical artifact 204, and/or in proximity of the associated physical artifact 204.

The associate physical artifact 204 is symbolically representative of an entity such as, for example, a person and/or a structure and the like. The entity information 210 contains information relating to the entity. In one instance, the entity information 210 can contain, for example, birth date, education, genealogy, experience, hobbies, samples of writings/works, and/or photographs and the like. In another instance, the entity information can contain, for example, building start date, building completion date, types of materials utilized, labor required, cost of completion, historical notes, ownership, designer, and/or purpose and the like. In still other instances, a complete set of data representative of an entity's entire lifetime (e.g., including medical records, school grades, marriages, taxes, wealth, webpages, and/or police records and the like) is included in the entity information 210. Thus, the amount and/or types of data associated with the entity is not limited in any manner.

The UI/Reader 206 provides a means to interactively interface with the immortal information component 202 and the self-disclosing, persistent stored information that is representative of the received entity information 210. The UI/Reader 206 enables the self-disclosing, persistent stored information to be experienced by the user 208. Due to the longevity of the immortalized information, it is possible that language changes, cultural changes, and/or political changes might alter the user's interpretation of the stored entity information 210. Thus, in one instance, the UI/Reader 206 can be utilized to properly present the information in an understandable format based upon current time and/or circumstance data. For example, if a language dialect has changed over time, the stored entity information 210 can be translated by the UI/Reader 206 so that the user 208 can easily understand the entity information 210. In another instance, for example, a holographic and/or video image of an entity can be altered by the UI/Reader 206 so that the entity appears in the correct attire for the user's time period. The UI/Reader 206 can also interact with the user 208 to perceive an appropriate sensory response to provide the user 208. This includes, but is not limited to, establishing whether the user 208 is visually impaired and then providing the information utilizing a visually impaired technique (e.g., Braille). Similarly, if the person is hearing impaired, captioning of visual experiences can be provided as well.

Likewise, information that was originally vague or somehow indeterminate at the time the entity information 21O was stored, can be enhanced by additional information with the UI/Reader 206. For example, if the phrase “I did this when my mother died” is utilized in the entity information 210, it 210 can be supplemented to show the user 208 that the entity's mother died on Aug. 28, 2012, thus, enhancing the stored entity information 210. In a similar fashion, if the entity is a structure, the UI/Reader 206 can provide supplemental information such as, for example, when a subsequent fire occurred in the structure and/or when a subsequent earthquake cracked the foundation of the structure. These events might have occurred subsequent to the storage of the entity information 210.

The UI/Reader 206, in some instances, can be an expandable device that provides advanced capabilities that may or may not have been envisioned at the time that the entity information 210 was stored. Thus, the UI/Reader 206 provides an expandability and/or enhancement means that can change over time to facilitate the user's interaction experience with the stored entity information 210. This can be accomplished in one instance via utilization of a series of capability layers that can increase in complexity over time to provide an updated “modem” interface at the time the user 208 is interacting with the immortal information system 200 without requiring the stored entity information 210 to change.

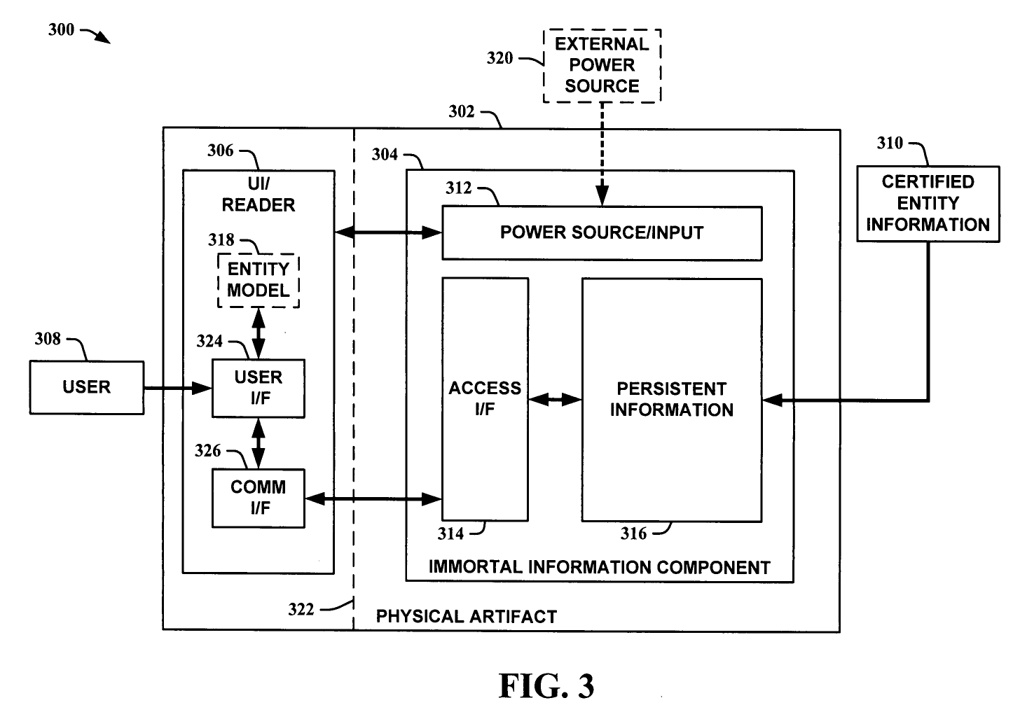

Looking at FIG. 3, yet another block diagram of an immortal information system in accordance with an aspect of an embodiment is depicted. The immortal information system 300 is comprised of a physical artifact 302, an immortal information component 304, and a User Interface (UI)/Reader 306. The UI/Reader 306 interfaces with a user 308. The immortal information component 304 and/or the UI/Reader 306 can also interface with a local network and/or a global network and the like as well to transfer, receive, and/or enhance information and/or models and the like. The immortal information component 304 receives certified entity information 310 and persistently stores it 310 in a self-disclosing manner. The certified entity information 310 permits an entity to obtain some type of guarantee that only information they select is actually immortally stored. Since the entity is typically not able to verify their information for the duration of the immortal information, a mechanism can be employed to ensure that the data content authenticity and/or integrity is maintained for the duration of the stored information. For example, a contract can be established for the desired results and/or establishing authenticity of the data can be passed as a willed item within generations of a family. This can be accomplished with various checksums and other data verification means such as, for example, with other “keys” to ensure that the data remains stable and unchanged from the originating data.

The immortal information component 304 is comprised of a power source/input 312, an access interface (I/F) 314, and persistent information 316. The persistent information 316 is immortalized information based on the certified entity information 310. One skilled in the art can appreciate that other instances can include immortalization of uncertified entity information as well and are within the scope of the subject matter. The persistent information 316 is encoded in a manner that provides “self revelation” of the immortalized information (i.e., the information is self-disclosing). In one instance, a basic encoding process based on ASCII (American Standard Code for Information Interchange) can be utilized. Encoding of the information can also utilize a nanotechnology-based process, an atomic arrangement-based process, a holographic-based process, a laser etching-based process, and/or an etched rock-based process and the like. These processes typically do not require moving parts and utilize materials that are generally inert for long periods of time.

During the lifespan of the immortalized data, it is conceivable that the encoding pattern can be forgotten. Thus, other instances can include keys to enable future generations to decode the information easily. Such keys, for example, can include basic information structures written utilizing multiple encoding types to increase the chance that at least one of the encoding types will prevail over time. In the same manner, instructions for reading the data can be included with the physical artifact and written in multiple languages such as, for example, English, Latin, and/or even hieroglyphics and the like.

The access interface 314 provides access and/or access control to the persistent information 316. The access interface 314 interacts with the UI/Reader 306 to retrieve the persistent information 316 in order to allow the user 308 to experience it 316. Instances that utilize the access interface 314 to provide access control enable an entity to provide embedded control before they are unable to. For example, access control can also be established utilizing the UI/Reader 306, however, the UI/Reader 306 can evolve over time and, thus, can be subject to tampering and/or even incorrect embellishments of the persistent information 316. Thus, data could be retrieved by individuals whom the entity did not want to have the information. By establishing access controls that are embedded with the persistent information 316, the entity regains control over who can access the information for the duration of its lifespan. Access control can be based on events that may be detected via the detection of physical activities or changes, such as the detection of some amount of physical destruction or damage to portions of the material adjacent to or surrounding the immortal computing system or subsystems, or a high degree of radiation, or a great, prolonged decrease in temperature below a threshold value of temperature, and news developments as encoded and transmitted by a news service employing the appropriate representation. Access control can be based simply on time as well (e.g., the persistent information 316 is not available to user “X” or anyone until 20 years from now—for example, a secretive source of information in a political scandal may wish information to come out about his or her role after their death; as another example, a one year old child with a parent who wants to give advice to them when they are 21 years old, etc.). Often, it is difficult to foresee all circumstances that can result in future generations and/or settings. To account for this, an entity can utilize a type of structured access to allow certain levels of information to be revealed. Thus, “classes” of users can be established, negating requiring the entity to make a list of access users and/or to try to guess who might wish to access the information in the future. For example, ‘direct descendents’ can be a class that has the highest level of access (verified by DNA type biometric access techniques, etc.). ‘Friends,’ ‘colleagues,’ and/or even paternal versus maternal kin can also be utilized as access control classes.

The power source/input 312 facilitates in allowing the persistent information 316 to be self-disclosing by providing the power necessary for the persistent information 316 to be accessed and retrieved. The power source/input 312 can be a self-sustaining power source embedded with the persistent information 316 such as, for example, a nuclear-based device with a half-life that allows the persistent information 316 to be utilized for a substantial portion of the life of the physical artifact 302. The power source/input 312 can also utilize a “non-direct” means of externally inducing and/or “exciting” power within the power source/input 312. These powering processes can include, but are not limited to, thermal-based techniques, light energy-based techniques, acoustical-based techniques, and/or magnetic induction-based techniques. For example, repeated force impulses to a flexible metallic structure can set off resonances generating power via piezoelectric and/or other transduction mechanism. By allowing external power excitation, the power source/input 312 can last almost indefinitely, as no internal moving parts and/or reactions are employed. The excitation itself can come from the UI/Reader 306 and/or an optional external power source 320. The optional external power source 320 allows for the option of, for example, powering all immortal information components found in an area utilizing a single device. This also alleviates the necessity of having a more complex UI/Reader 306 that has a power transfer process as part of its construction. The excitation of the power source/input 312 can have a duration such that it is unnecessary for it 312 to be continuously excited by the UI/Reader 306 and/or the optional external power source 320 (e.g., several hours allowing users to interact during a 'visitation period'without re-exciting the embedded power). This is particularly useful if the excitation means has harmful effects to those in the immediate area.

The UI/Reader 306 interfaces with the access interface 314 and the user 308. The UI/Reader 306 “translates” the persistent information 316 such that it is useable by the user 308. The translation can include, for example, actually translating to different languages and the like, but it can also include utilizing captions for hearing impaired users and describing images to visually impaired users and the like as described previously. The UI/Reader 306 can also “enhance” the experience by utilizing multimedia presentations and other sensory enhancements and the like. Thus, an entity might have described his dog Spot and encoded that into the persistent information 316. The UI/Reader 306 can enhance the persistent information 316 by displaying an actual image of Spot from the persistent information 316 and/or generate an image of a dog very similar to Spot for the user 308 to see. The UI/Reader 306 can also interact with the user 308 and ascertain characteristics of the user 308. For example, if the user 308 is determined to be under the age of five, the UI/Reader 306 can limit the retrieval of the persistent information 316 to information appropriate for a child of that age.

As noted previously, other types of access control, such as those employed by the access interface 314, can also be utilized by the UI/Reader 306. For example, if an entity had remarried during their lifetime, information regarding certain periods of time during their life can be restricted based on the bloodline (i.e., DNA) of the user 308. Thus, offspring of the first marriage can be excluded from personal information relating to offspring of the second marriage and the like. One skilled in the art can appreciate the substantial flexibility that instances of the subject matter provide and, thus, understand that it is impossible to enumerate all variations that are within the scope of the subject matter.

The UI/Reader 306 is comprised of a user interface 324 and a communication component 326. The communication component 326 interacts with the physical artifact 304 to obtain the persistent information 316. This information is then passed to the user interface 324 that can process the persistent information 324 and relay it to the user 308. The UI/Reader 306 can also include an optional entity model 318 that can interact with the user interface 324. The optional entity model 318 can include, but is not limited to, a personalized interaction model based on an entity. The personalized interaction model allows the UI/Reader 306 to interact with the user 308 as if the UI/Reader 306 was actually the entity. Thus, the user 308 can present queries to the UI/Reader 306 and it 306 can respond in a manner consistent with the characteristics of the entity. For example, a great-grandchild of an entity can utilize the UI/Reader 306 to ask their great-grandfather how to ride a bicycle. It is conceivable that the entity did not have the foresight to know that he would have a great-grandchild and that they would ask this specific question. However, the personalized interaction model can be constructed such that the UI/Reader 306 can respond to the child in a manner consistent with how the entity might have responded in the same situation. This allows the child “to get to know” their ancestor in a manner not possible without instances of the subject matter. Likewise, great scholars can sit down and have lengthy discussions with historically significant figures and learn how they might have dealt with situations that are presently occurring. Medical doctors can call upon great healers and scientific minds to facilitate them in their daily practices. Parents with terminal illnesses can still give parenting advice to their children even after their early demise. Thus, the optional entity model 318 can also include personal characterizations, business characterizations, military characterizations, political characterizations, parenting characterizations, and/or counseling characterizations and the like. The entity can even prescribe which entity models that they prefer to have constructed based upon their immortalized information.

The UI/Reader 306 can be part of the physical artifact 302 and/or it 306 can be separate from the physical artifact 302 as denoted by the dashed line 322. This allows instances of the subject matter to have the functionality of the UI/Reader 306 embedded and/or in proximity of the physical artifact 302. It also allows the UI/Reader 306 to be upgraded and/or enhanced over time while the persistent information 316 remains unchanged. Thus, as technology improves, the UI/Reader 306 can improve as well without impacting the immortal information component 304 and/or the physical artifact 302.

The UI/Reader 306 can also provide the power for the power source/input 312 as described above. Similar methodologies for transferring or exciting power to the immortal information component 304 can also be utilized to provide interaction between the immortal information component 304 and the UI/Reader 306. Thus, for example, channeled light energy, magnetic induction, acoustical energy, and/or thermal-based techniques can be employed as communication means between the UI/Reader 306 and the immortal information component 304. This allows the UI/Reader 306 to interface with the immortal information component 304 even in instances where the immortal information component 304 is embedded into the physical artifact 302. In a simple form, the UI/Reader 306 can be a writing tablet type of computing device that the user 308 can utilize to interact with the persistent information 316. The computing device can utilize, for example, an infrared-based communication means to obtain the persistent information 316.

As described above, the UI/Reader 306 can also provide access control and/or access control information (e.g., depending on whether the UI/Reader 306 controls access and/or the access interface 314 controls access and needs access class information, etc.). Thus, the UI/Reader 306 can utilize biometric-based devices and/or other devices to determine identity (fingerprint reading, etc.), bloodline (DNA sampling, etc.), age (scanning of features and dimensions of the user, etc.), and/or impairments (sight and/or hearing impairment detecting, etc.). It 306 can utilize this information directly to control access and/or pass it to the immortal information component 304 so that it 304 can utilize the information to control access internally (e.g., based on previously sanctioned classes of access authorized by the entity, etc.).

As the duration of the storage life increases, it is possible that methods utilized to read the persistent information may take longer. Other instances of the subject matter can augment the immortal computing by utilizing several layers of caching mechanisms which span the continuum of the dual concepts of longevity and speed; much like random access memory (RAM) is to a hard drive. In one instance of the subject matter, the physical artifact's persistent information can be transcribed to a faster, more contemporary, yet more fragile medium that is more easily accessed. For example, a book (i.e., transcription) can be written that sits in a library; perhaps it gives the content of a stone engraving (i.e., physical artifact with persistent information represented by the engraving). This book can be easily translated and stored on the Web—thus, in this example, the system has three copies of the same data. The Web version is likely to be the most fragile but most useful, the book perhaps longer lived but harder to find, and, thus, harder to read, while the stone tablet is the least accessible but longest lived. Occasionally, a new book can be written about the stone engraving, restoring the book-form's longevity, and can be translated again to the Web, etc. The book and the Web document can be viewed as level 1 and level 2 cached versions of the stone engraving (i.e., persistent information). Additionally, they provide a manner of backup in the event the stone engraving (i.e., persistent information) is lost. This concept can be extended to the power and communications as well.

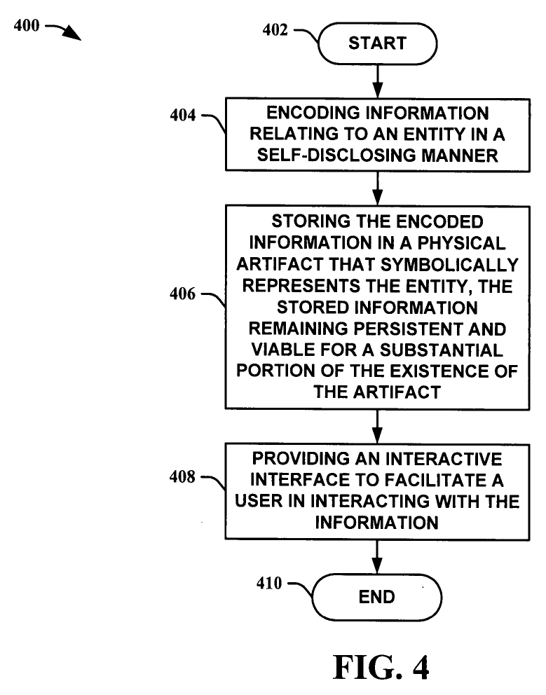

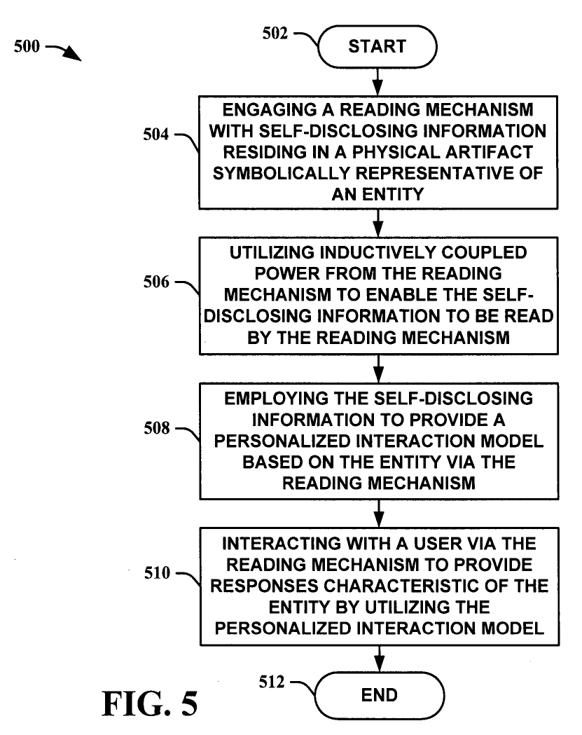

In view of the exemplary systems shown and described above, methodologies that may be implemented in accordance with the subject matter will be better appreciated with reference to the flow charts of FIGS. 4 and 5. While, for purposes of simplicity of explanation, the methodologies are shown and described as a series of blocks, it is to be understood and appreciated that the subject matter is not limited by the order of the blocks, as some blocks may, in accordance with the subject matter, occur in different orders and/or concurrently with other blocks from that shown and described herein. Moreover, not all illustrated blocks may be required to implement the methodologies in accordance with the subject matter.

The subject matter may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the subject matter.

In FIG. 4, a flow diagram of a method 400 of facilitating immortal information storage and retrieval in accordance with an aspect of an embodiment is shown. The method 400 starts 402 by encoding information relating to an entity in a self-disclosing manner 404. In one instance, a basic encoding process based on ASCII (American Standard Code for Information Interchange) can be utilized. Encoding of the information can also utilize a nanotechnology-based process, an atomic arrangement-based process, a holographic-based process, a laser etching-based process, and/or an etched rock-based process and the like. Thus, in some instances, for example, technologies such as those utilized with compact discs and/or digital video discs can be employed to facilitate the type and/or manner of encoding. These processes typically do not require moving parts and utilize materials that are generally inert for long periods of time.

During the lifespan of the immortalized data, it is conceivable that the encoding type can be forgotten. Thus, other instances can include keys to enable future generations to decode the information easily. Such keys, for example, can include basic information structures written utilizing multiple encoding types to increase the chance that at least one of the encoding types will prevail over time. In the same manner, instructions for reading the data can be included with the physical artifact and written in multiple languages such as, for example, English, Latin, and/or even hieroglyphics and the like.

For example, instructions for building a decoder for a root-level of the entity-related information can be encoded in proximity to the entity-related information in a substantially self-revealing manner. In one approach, a user can be instructed to build decoder for the entity-related information based on a set of successive phases of construction and revelation, where the tools built for the first phase, describe tools and methods for building a second set of tools, and so on, until the base-level information can be decoded. That is, for example, the process starts with simple, easy to decode symbols that are salient, easy to find, and to decode, perhaps with some basic symbols that any intelligence capable of understanding the concepts at the root-level would understand. Eventually, in an iterative manner, a final decoder and/or power assembly can be built, allowing revelation of the stored entity-related information.

The encoded information is then stored in a physical artifact that symbolically represents the entity, the stored information remaining persistent and viable for a substantial portion of the existence of the artifact 406. The entity itself can be organic and/or inorganic. Thus, the entity can be a person and/or a structure and the like. Physical artifacts can include, but are not limited to, tombstones and/or urns associated with the remains of the entity, memorials, and/or building cornerstones and the like. An interactive interface is then provided to facilitate a user in interacting with the information 408, ending the flow 410. One instance utilizes a separate interactive interface to inductively provide power to interact with the stored information and to provide an interface for the user. In still other instances, the interactive interface can be upgraded to allow a series of capability layers that interact with the stored information, providing additional features such as interactive models, holographic imaging, video, and/or other forms of sensory information. These instances can provide invaluable information to future generations of users for the approximate life of the physical artifact, greatly increasing the historical knowledge of society as a whole.

Turning to FIG. 5, a flow diagram of a method 500 of interacting with personalized immortal information in accordance with an aspect of an embodiment is depicted. The method 500 starts 502 by engaging a reading mechanism with self-disclosing information residing in a physical artifact symbolically representative of an entity 504. Inductively coupled power from the reading mechanism is then utilized to enable reading of the self-disclosing information by the reading mechanism 506. The self-disclosing information is then employed via the reading mechanism to provide a personalized interaction model based on the entity 508. Responses characteristic of the entity are then provided by the personalized interaction model to a user via interaction with the reading mechanism 510, ending the flow 512.

The personalized interaction model allows the reading mechanism to interact with the user as if the reading mechanism was actually the entity. Thus, the user can present queries to the reading mechanism and it can respond in a manner consistent with the characteristics of the entity. This, for example, allows people “to get to know” their ancestors in a manner not possible without instances of the subject matter. The personalized interaction model can include personal characterizations, business characterizations, military characterizations, political characterizations, parenting characterizations, and/or counseling characterizations and the like. The entity can even prescribe which entity models that they prefer to have constructed based upon their immortalized information.

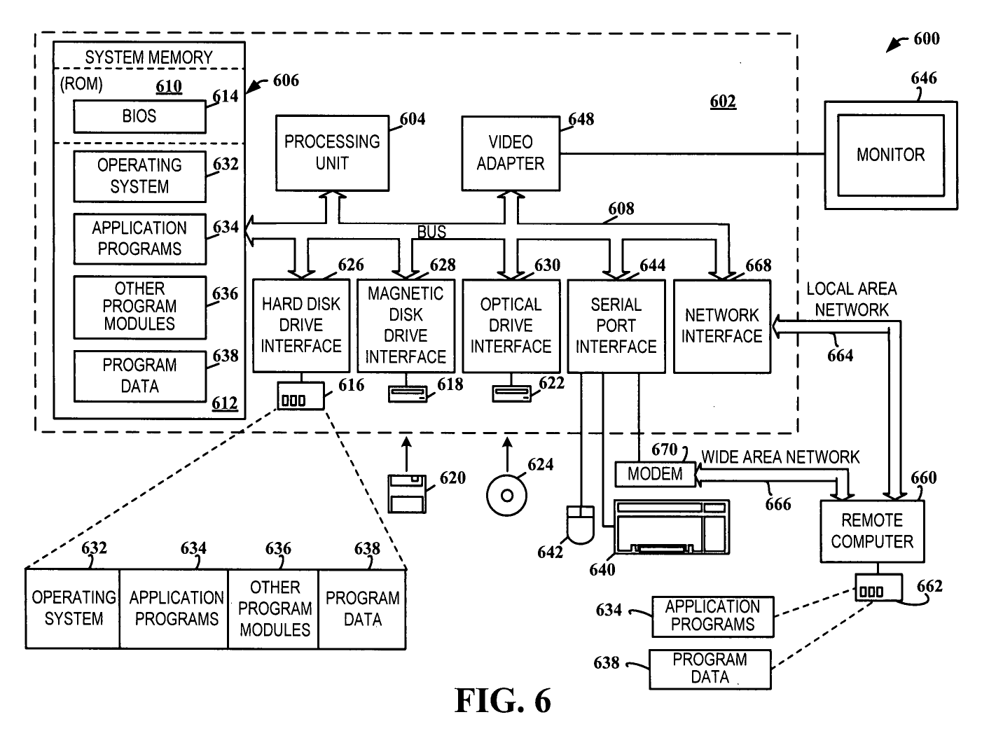

In order to provide additional context for implementing various aspects of the subject matter, FIG. 6 and the following discussion is intended to provide a brief, general description of a suitable computing environment 600 in which the various aspects of the subject matter may be implemented. While the subject matter has been described above in the general context of computer-executable instructions of a computer program that runs on a local computer and/or remote computer, those skilled in the art will recognize that the subject matter also may be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the subject matter may also be practiced in distributed computing environments where certain tasks are performed by remote processing devices that are linked through a communications network. However, some, if not all, aspects of the subject matter may be practiced on stand-alone computers. In a distributed computing environment, program modules may be located in local and/or remote memory storage devices.

As used in this application, the term “component” is intended to refer to a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents.

With reference to FIG. 6, an exemplary system environment 600 for implementing the various aspects of the subject matter includes a conventional computer 602, including a processing unit 604, a system memory 606, and a system bus 608 that couples various system components, including the system memory, to the processing unit 604. The processing unit 604 may be any commercially available or proprietary processor. In addition, the processing unit may be implemented as multi-processor formed of more than one processor, such as may be connected in parallel.

The system bus 608 may be any of several types of bus structure including a memory bus or memory controller, a peripheral bus, and a local bus using any of a variety of conventional bus architectures such as PCI, VESA, Microchannel, ISA, and EISA, to name a few. The system memory 606 includes read only memory (ROM) 610 and random access memory (RAM) 612. A basic input/output system (BIOS) 614, containing the basic routines that help to transfer information between elements within the computer 602, such as during start-up, is stored in ROM 610.

The computer 602 also may include, for example, a hard disk drive 616, a magnetic disk drive 618, e.g., to read from or write to a removable disk 620, and an optical disk drive 622, e.g., for reading from or writing to a CD-ROM disk 624 or other optical media. The hard disk drive 616, magnetic disk drive 618, and optical disk drive 622 are connected to the system bus 608 by a hard disk drive interface 626, a magnetic disk drive interface 628, and an optical drive interface 630, respectively. The drives 616-622 and their associated computer-readable media provide nonvolatile storage of data, data structures, computer-executable instructions, etc. for the computer 602. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 600, and further that any such media may contain computer-executable instructions for performing the methods of the subject matter.

A number of program modules may be stored in the drives 616-622 and RAM 612, including an operating system 632, one or more application programs 634, other program modules 636, and program data 638. The operating system 632 may be any suitable operating system or combination of operating systems. By way of example, the application programs 634 and program modules 636 can include an information storage and retrieval scheme in accordance with an aspect of the subject matter.

A user can enter commands and information into the computer 602 through one or more user input devices, such as a keyboard 640 and a pointing device (e.g., a mouse 642). Other input devices (not shown) may include a microphone, a joystick, a game pad, a satellite dish, a wireless remote, a scanner, or the like. These and other input devices are often connected to the processing unit 604 through a serial port interface 644 that is coupled to the system bus 608, but may be connected by other interfaces, such as a parallel port, a game port or a universal serial bus (USB). A monitor 646 or other type of display device is also connected to the system bus 608 via an interface, such as a video adapter 648. In addition to the monitor 646, the computer 602 may include other peripheral output devices (not shown), such as speakers, printers, etc.

It is to be appreciated that the computer 602 can operate in a networked environment using logical connections to one or more remote computers 660. The remote computer 660 may be a workstation, a server computer, a router, a peer device or other common network node, and typically includes many or all of the elements described relative to the computer 602, although for purposes of brevity, only a memory storage device 662 is illustrated in FIG. 6. The logical connections depicted in FIG. 6 can include a local area network (LAN) 664 and a wide area network (WAN) 666. Such networking environments are commonplace in offices, enterprise-wide computer networks, intranets and the Internet.

When used in a LAN networking environment, for example, the computer 602 is connected to the local network 664 through a network interface or adapter 668. When used in a WAN networking environment, the computer 602 typically includes a modem (e.g., telephone, DSL, cable, etc.) 670, or is connected to a communications server on the LAN, or has other means for establishing communications over the WAN 666, such as the Internet. The modem 670, which can be internal or external relative to the computer 602, is connected to the system bus 608 via the serial port interface 644. In a networked environment, program modules (including application programs 634) and/or program data 638 can be stored in the remote memory storage device 662. It will be appreciated that the network connections shown are exemplary and other means (e.g., wired or wireless) of establishing a communications link between the computers 602 and 660 can be used when carrying out an aspect of the subject matter.

In accordance with the practices of persons skilled in the art of computer programming, the subject matter has been described with reference to acts and symbolic representations of operations that are performed by a computer, such as the computer 602 or remote computer 660, unless otherwise indicated. Such acts and operations are sometimes referred to as being computer-executed. It will be appreciated that the acts and symbolically represented operations include the manipulation by the processing unit 604 of electrical signals representing data bits which causes a resulting transformation or reduction of the electrical signal representation, and the maintenance of data bits at memory locations in the memory system (including the system memory 606, hard drive 616, floppy disks 620, CD-ROM 624, and remote memory 662) to thereby reconfigure or otherwise alter the computer system's operation, as well as other processing of signals. The memory locations where such data bits are maintained are physical locations that have particular electrical, magnetic, or optical properties corresponding to the data bits.

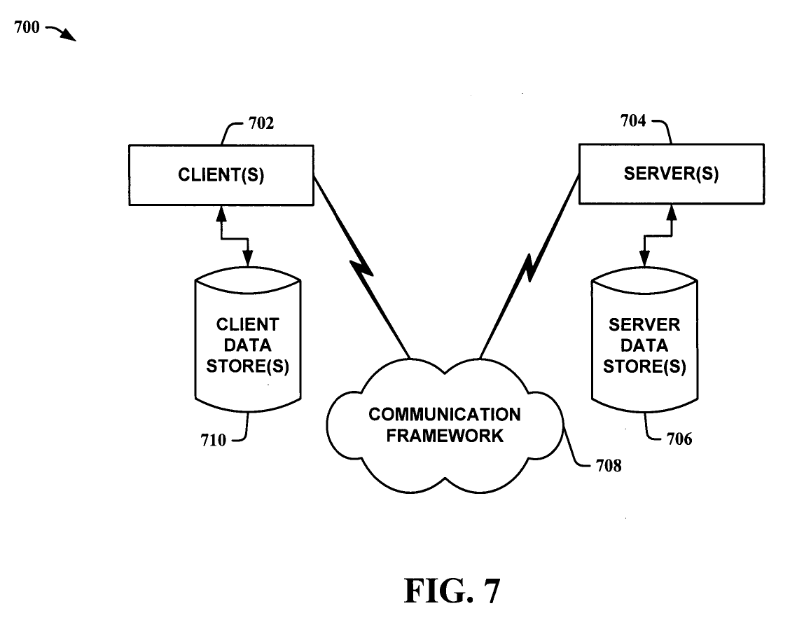

FIG. 7 is another block diagram of a sample computing environment 700 with which an embodiment can interact. The system 700 further illustrates a system that includes one or more client(s) 702. The client(s) 702 can be hardware and/or software (e.g., threads, processes, computing devices). The system 700 also includes one or more server(s) 704. The server(s) 704 can also be hardware and/or software (e.g., threads, processes, computing devices). One possible communication between a client 702 and a server 704 may be in the form of a data packet adapted to be transmitted between two or more computer processes. The system 700 includes a communication framework 708 that can be employed to facilitate communications between the client(s) 702 and the server(s) 704. The client(s) 702 are connected to one or more client data store(s) 710 that can be employed to store information local to the client(s) 702. Similarly, the server(s) 704 are connected to one or more server data store(s) 706 that can be employed to store information local to the server(s) 704.

It is to be appreciated that the systems and/or methods of the subject matter can be utilized in information storage and retrieval facilitating computer components and non-computer related components alike. Further, those skilled in the art will recognize that the systems and/or methods of the subject matter are employable in a vast array of electronic related technologies, including, but not limited to, computers, servers and/or handheld electronic devices, and the like.

What has been described above includes examples of the subject matter. It is, of course, not possible to describe every conceivable combination of components or methodologies for purposes of describing the subject matter, but one of ordinary skill in the art may recognize that many further combinations and permutations of the subject matter are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates information storage and retrieval comprising:
a physical artifact that symbolically represents an entity; and
an immortal information component associated with the artifact that provides self-disclosing, persistent information relating to the entity for a substantial portion of the existence of the artifact.

2. The system of claim 1, the immortal information component is part of the physical artifact.

3. The system of claim 1, the immortal information component interacts with a local and/or global network.

4. The system of claim 1, the immortal information component provides an interactive user interface to allow a user to interface with the persistent information.

5. The system of claim 4, the user interface provides at least one visual and/or auditory response associated with the entity to a user query.

6. The system of claim 1, the physical artifact comprising a symbolic representation of an entity's remains.

7. The system of claim 6, the entity's remains comprising organic remains.

8. The system of claim 7, the organic remains comprising human and/or animal remains.

9. The system of claim 6, the physical artifact comprising a tombstone and/or urn associated with the entity's remains.

10. The system of claim 1, the physical artifact comprising a building cornerstone and/or a memorial for the entity.

11. The system of claim 1, the immortal information component utilizes a magnetic induction, chemical, acoustical energy, light energy and/or thermal-based power source to facilitate in providing information relating to the entity.

12. The system of claim 1, the immortal information component provides access control to the information.

13. The system of claim 13, the access control is based, at least in part, on a biometric-based access means.

14. A method for facilitating information storage and retrieval comprising, comprising:
encoding information relating to an entity in a self-disclosing manner;
storing the encoded information in a physical artifact that symbolically represents the entity, the stored information remaining persistent and viable for a substantial portion of the existence of the artifact; and
providing an interactive interface to facilitate a user in interacting with the information.

15. The method of claim 14 further comprising:
encoding and storing instructions, in a substantially self-revealing manner, for building an information decoder for a root-level of the stored entity-related information; the instructions stored in proximity of the stored entity-related information.

16. The method of claim 15 further comprising:
encoding and storing elemental instructions for iterative revelation of fundamental decoding information to facilitate in constructing the information decoder and/or power source to reveal the root-level entity-related information.

17. The method of claim 14 further comprising:
providing power to facilitate in interacting with the information utilizing a magnetic induction power process, acoustical induction power process, chemical sources, a light energy power process, and/or a thermal-based power process.

18. The method of claim 14 further comprising:
providing a personalized interaction model based on the entity, at least in part, to facilitate interaction with the stored information.

19. The method of claim 14 further comprising:
encoding the information utilizing a nanotechnology-based process, an atomic arrangement-based process, a holographic-based process, a laser etching-based process, and/or an etched rock-based process.

20. The method of claim 14 further comprising:
certifying the information associated with the entity to ensure that the information is permissible to the entity.

21. The method of claim 14 further comprising:
controlling access to the information to ensure that a user has authorization to interact with the information.

22. An interface system that facilitates immortal information retrieval, comprising:
a communications component that communicates with a physical artifact that symbolically represents an entity; and
a user interface that relays user information based, at least in part, on persistent information obtained from the physical artifact that relates to the entity, the persistent information obtainable for a substantial portion of the existence of the artifact.
